(19) United States
(12) Patent Application Publication
(10) Pub. No.: US 2023/0224816 A1
(43) Pub. Date: Jul. 13, 2023

(54) COMMUNICATION CONTROL METHOD AND APPARATUS, COMMUNICATION DEVICE AND STORAGE MEDIUM

(71) Applicant: SPREADTRUM COMMUNICATIONS (SHANGHAI) CO., LTD., Shanghai (CN)

(72) Inventors: Yongsheng ZHANG, Shanghai (CN); Qiao ZHANG, Shanghai (CN); Jiaxuan CHEN, Shanghai (CN); Xinfa LIANG, Shanghai (CN)

(21) Appl. No.: 18/003,814

(22) PCT Filed: Apr. 2, 2021
(86) PCT No.: PCT/CN2021/085242

§ 371 Date: Dec. 29, 2022

(30) Foreign Application Priority Data
Jun. 30, 2020 (CN) 202010616401.5

(51) Int. Cl. H04W 52/14; H04W 52/42; H04W 52/02; H04W 52/36

(52) U.S. Cl. CPC H04W 52/14; H04W 52/42; H04W 52/0245; H04W 52/367

(57) ABSTRACT

Provided are a communication control method, a communication device and a non-transitory computer-readable storage medium. The method includes: performing, by a 5G chip, cell search and synchronization with a base station; acquiring, by the 5G chip, timeslot ratio information of an uplink timeslot and a downlink timeslot; and controlling, by a 4G chip, on-off states of an amplification uplink and an amplification downlink based on the timeslot ratio information.

This application claims priority to Chinese Patent Application No. 202010616401.5, titled “COMMUNICATION CONTROL METHOD AND APPARATUS, COMMUNICATION DEVICE AND STORAGE MEDIUM”, filed on Jun. 30, 2020, with the China National Intellectual Property Administration (CNIPA), which is incorporated herein by reference in its entirety.

### FIELD

The present disclosure relates to the technical field of communications, in particular to a communication control method and apparatus, a communication device and a storage medium.

### BACKGROUND

Mobile communication signals are weak in indoor environments such as large buildings, underground shopping malls and underground parking lots, and such environments are very easy to form blind areas and shadow areas for mobile communication, resulting in that mobile phones and other terminals which use the mobile communication signals cannot be normally used. An indoor distribution system may be used to enhance mobile communication signals in the indoor environment. The indoor distribution system can evenly distribute base station signals to all corners of the indoor environment, thereby ensuring an ideal signal coverage in the indoor environment.

Signal sources of the indoor distribution system mainly include: a macro cell as a signal source to access the indoor distribution system; a micro cell as a signal source to access the indoor distribution system; and a repeater as a signal source to access the indoor distribution system. The repeater is used to perform spatial coupling through a donor antenna or direct coupling through a coupler with a base station signal with surplus capacity, amplify a received signal, and provide the amplified signal to the indoor distribution system. It can be seen that the indoor distribution system may be directly connected to the base station signal, alternatively, the repeater may be connected to the base station signal, and then the repeater may provide the base station signal to the indoor distribution system.

With the acceleration of 5G (the fifth-generation mobile communication technology) construction, it is a problem to be urgently solved by those skilled in the art that how to achieve 5G communication control on a basis of 4G (the fourth-generation mobile communication technology) when the indoor distribution system is connected to the base station signal or the repeater is connected to the base station signal.

### SUMMARY

In view of this, a communication control method and apparatus, a communication device and a storage medium are provided according to embodiments of the present disclosure, so as to achieve 5G communication control on a basis of 4G.

In order to achieve the above objectives, the following technical solutions are provided according to embodiments of the present disclosure.

A communication control method includes:
performing, by a 5G chip, cell search and synchronization with a base station;
acquiring, by the 5G chip, timeslot ratio information of an uplink timeslot and a downlink timeslot; and
controlling, by a 4G chip, on-off states of an amplification uplink and an amplification downlink based on the timeslot ratio information.

In an embodiment, the controlling, by the 4G chip, the on-off states of the amplification uplink and the amplification downlink based on the timeslot ratio information includes:
controlling, by the 4G chip, a turn-on time period of the amplification downlink to cover all downlink timeslot transmission time periods, and controlling, by the 4G chip, a turn-on time period of the amplification uplink to cover all uplink timeslot transmission time periods; and/or
controlling, by the 4G chip, a preset guard time interval to exist between an end time instant of the amplification downlink and a start time instant of the amplification uplink.

In an embodiment, the acquiring, by the 5G chip, the timeslot ratio information of the uplink timeslot and the downlink timeslot includes:
reading, by the 5G chip, a broadcast signal of the base station, and acquiring, by the 5G chip, the timeslot ratio information of the uplink timeslot and the downlink timeslot from the broadcast signal of the base station.

In an embodiment, the reading, by the 5G chip, the broadcast signal of the base station, and acquiring, by the 5G chip, the timeslot ratio information of the uplink timeslot and the downlink timeslot from the broadcast signal of the base station includes:
reading, by the 5G chip, a first system information block and acquiring, by the 5G chip, the timeslot ratio information from the first system information block.

In an embodiment, the communication control method further includes:
acquiring, by the 5G chip, a value of a received signal strength indication (RSSI); and
controlling, by the 4G chip, a front-stage low noise amplifier (LNA) to be in a normal operating mode or in a bypass mode according to the value of the RSSI.

In an embodiment, the controlling, by the 4G chip, the front-stage LNA to be in the normal operating mode or in the bypass mode according to the value of the RSSI includes:
controlling, by the 4G chip, the front-stage LNA to be in the normal operating mode, in a case that the value of the RSSI is less than a preset value; and
controlling, by the 4G chip, the front-stage LNA to be in the bypass mode, in a case that the value of the RSSI is greater than or equal to a setting value.

In an embodiment, the communication control method further includes:
acquiring, by the 5G chip, an expected uplink power of the base station from a broadcast signal of the base station;
determining, by the 4G chip, a maximum uplink transmission power based on the expected uplink power of the base station; and
transmitting, by the 4G chip, a signal on the amplification uplink based on the maximum uplink transmission power.

In an embodiment, the determining, by the 4G chip, the maximum uplink transmission power based on the expected uplink power of the base station includes:
determining, by the 4G chip, an uplink open-loop power control power based on the expected uplink power of the base station; and
selecting, by the 4G chip, a smaller value between the uplink open-loop power control power and a setting maximum uplink transmission power as the maximum uplink transmission power.

In an embodiment, the performing, by the 5G chip, synchronization with the base station includes:
receiving, by the 5G chip, a downlink base station signal, and performing, by the 5G chip, synchronization with the base station based on the downlink base station signal.

A communication control apparatus is further provided according to an embodiment of the present disclosure, and includes:
a search and synchronization module, configured to perform cell search and synchronization with a base station through a 5G chip;
a ratio information acquisition module, configured to acquire timeslot ratio information of an uplink timeslot and a downlink timeslot through the 5G chip; and
a control module, configured to control on-off states of an amplification uplink and an amplification downlink based on the timeslot ratio information through a 4G chip.

A communication device is further provided according to an embodiment of the present disclosure. The communication device includes a 5G chip and a 4G chip;
the 5G chip is configured to perform cell search and synchronization with a base station, and acquire timeslot ratio information of an uplink timeslot and a downlink timeslot; and
the 4G chip is configured to control on-off states of an amplification uplink and an amplification downlink based on the timeslot ratio information.

A storage medium is further provided according to an embodiment of the present disclosure. The storage medium stores one or more pieces of computer-executable instructions. The one or more pieces of computer-executable instructions are used to perform the communication control method described above.

In the communication control method according to the embodiments of the present disclosure, a communication device (such as a repeater or an indoor distribution system) may perform cell search and synchronization with a base station through a 5G chip, and acquire timeslot ratio information of an uplink timeslot and a downlink timeslot, so that the communication device can control on-off states of the amplification uplink and the amplification downlink based on the timeslot ratio information through a 4G chip after the communication device establishes 5G connection and synchronization with the base station through the 5G chip. It can be seen that in the embodiments of the present disclosure, the 4G chip of the communication device can realize on-off control of the amplification uplink and the amplification downlink of the communication device under 5G communication after the 5G chip of the communication device establishes the 5G connection and synchronization with the base station, so that an outdoor base station signal can be amplified and transmitted indoors via the amplification downlink, and the indoor signal can be transmitted outdoors via the amplification uplink, thereby achieving 5G communication control on a basis of 4G.

### BRIEF DESCRIPTION OF THE DRAWINGS

In order to more clearly illustrate technical solutions in embodiments of the present disclosure or in the conventional technology, the drawings to be used in the description of the embodiments or the conventional technology are briefly described below. Apparently, the drawings in the following description show only some embodiments of the present disclosure, and other drawings may be obtained by those skilled in the art from the provided drawings without any creative work.

FIG. 1 is a principal diagram of an indoor distribution system or a repeater;

FIG. 2 is a schematic diagram of an indoor distribution system;

FIG. 3 is a flow chart of a communication control method according to an embodiment of the present disclosure;

FIG. 4 is a schematic diagram showing that on-off states of an amplification uplink and an amplification downlink are controlled based on timeslot ratio information;

FIG. 5 is a flow chart of a communication control method according to another embodiment of the present disclosure;

FIG. 6 is a flow chart of a communication control method according to another embodiment of the present disclosure;

FIG. 7 is a flow chart of determining a maximum uplink transmission power according to an embodiment of the present disclosure;

FIG. 8 is a block diagram of a communication control apparatus according to an embodiment of the present disclosure;

FIG. 9 is a block diagram of a communication control apparatus according to another embodiment of the present disclosure;

FIG. 10 is a block diagram of a communication control apparatus according to another embodiment of the present disclosure; and

FIG. 11 is a schematic diagram of a communication device.

### DETAILED DESCRIPTION

For the sake of the signal coverage indoors, in an embodiment of the present disclosure, an indoor distribution system may be directly connected to an outdoor base station signal, and after the base station signal is processed by the indoor distribution system, the base station signal can be covered indoors. Alternatively, a repeater may be connected to the outdoor base station signal, the base station signal is processed by the repeater and then transmitted to the indoor distribution system, and the indoor distribution system realizes the indoor coverage of the base station signal.

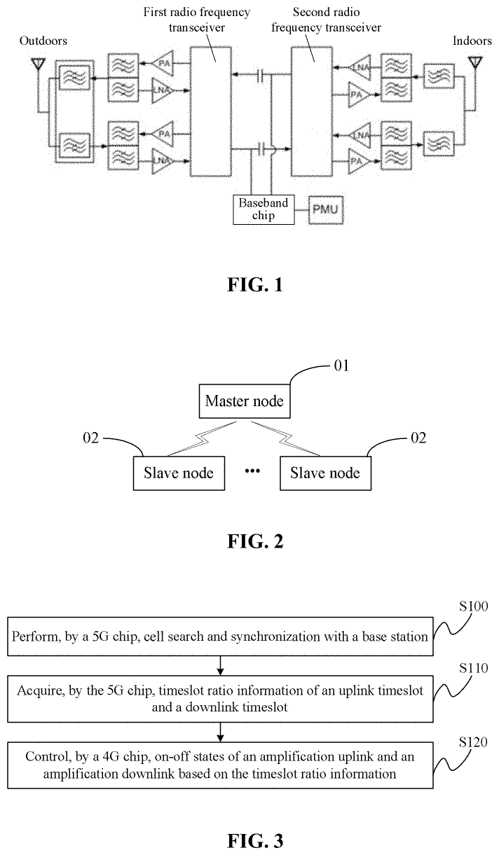

In an example, FIG. 1 shows a principal diagram of an indoor distribution system or a repeater. In FIG. 1, PA (Power Amplifier) represents a power amplifier, LNA (Low Noise Amplifier) represents a low noise amplifier, and PMU (Power Management Unit) represents a power management unit. It can be seen from FIG. 1 that an outdoor radio frequency part receives an outdoor base station signal and transmits the outdoor base station signal to a baseband chip, the baseband chip is synchronized and resides in a suitable cell, and then an indoor radio frequency part is turned on, and the base station signal is amplified and transmitted indoors. As shown in FIG. 1, a link where an outdoor base station signal is amplified and then transmitted indoors may be defined as an amplification downlink, and a link where an indoor signal is amplified and then transmitted outdoors may be defined as an amplification uplink. When a signal is amplified and transmitted outdoors on the amplification uplink, the signal also enters to the baseband chip, and the baseband chip performs frequency tracking, power control and other processing according to the received signal.

In a further description, as shown in FIG. 2, the indoor distribution system mainly includes a master node 01 and multiple slave nodes 02. The master node is connected to the base station signal and transmits the base station signal to the slave nodes. The master node may be directly connected to an outdoor base station signal, or the master node may be connected to a base station signal provided by a repeater. The slave nodes process the received base station signal and transmit the processed base station signal to an air interface, so as to realize the indoor coverage of the base station signal. It can be seen that in the indoor distribution system, the master node may be connected to the base station signal, process the base station signal and then transmit the processed base station signal to the slave nodes.

In a scenario of signal coverage indoors, the indoor distribution system may be directly connected to an outdoor base station signal or may be connected to a base station signal provided by a repeater. Though with the acceleration of 5G construction, the repeater or the indoor distribution system is usually built on a basis of 4G and does not support 5G with high-frequency band, and passive devices have large loss and uneven quality, and the end coverage cannot meet the requirements. Moreover, with the high-speed requirement of 5G, the indoor distribution system currently does not support MIMO (Multiple-In Multiple-Out) of 5G. If two passive indoor distribution systems are newly built to support MIMO (multiple-in multiple-out), the cost is high and the construction is difficult, and it is difficult to achieve complete real-time monitoring of network management, as well as management, maintenance and troubleshooting. It can be seen that the current repeater or indoor distribution system built on the basis of 4G is difficult to achieve 5G communication control, which leads to some further problems. Therefore, how to achieve 5G communication control by the repeater or the indoor distribution system on the basis of 4G is a technical problem to be urgently solved by those skilled in the art.

The technical solutions according to the embodiments of the present disclosure are described clearly and completely as follows in conjunction with the drawings in the embodiments of the present disclosure. It is apparent that the described embodiments are only part of rather than all of embodiments of the present disclosure. Any other embodiments obtained by those skilled in the art based on the embodiments in the present disclosure without any creative work shall fall within the protection scope of the present disclosure.

In an embodiment of the present disclosure, a communication device may be provided with a 5G chip and a 4G chip. The 5G chip is used for cell search and synchronization with a base station, and thus the 4G chip is used for communication control based on information provided by the 5G chip, so as to achieve 5G communication control on a basis of 4G. That is, in the embodiment of the present disclosure, the cell search and the synchronization with a base station may be performed by the 5G chip, and the communication control may be performed by the 4G chip. It should be noted that the communication device may be a repeater or an indoor distribution system. In a case that the communication device is the indoor distribution system, the communication device may be specifically a master node in the indoor distribution system.

In an embodiment, FIG. 3 shows a flow chart of a communication control method according to an embodiment of the present disclosure. The process shown in FIG. 3 may be performed by a communication device. As shown in FIG. 3, the process may include the following steps S100 to S120.

In step S100, cell search and synchronization with a base station are performed by a 5G chip.

The step S100 may be implemented by the 5G chip of the communication device. In an embodiment, when the communication device is powered on, the 5G chip of the communication device may perform cell search and synchronization with a base station.

In an embodiment of the present disclosure, during the synchronization with a base station, the 5G chip may be used to receive a downlink base station signal, and perform synchronization with the base station based on the downlink base station signal. Apparently, the synchronization with the base station may be implemented in another way, which is not limited in the embodiment of the present disclosure.

During the process of cell search and synchronization with a base station by the 5G chip, an amplification uplink and an amplification downlink of the communication device are kept in an off state, that is, the communication device does not amplify or transmit the indoor signal outdoors, and also does not amplify or transmit an outdoor base station signal indoors.

In step S110, timeslot ratio information of an uplink timeslot and a downlink timeslot is acquired by the 5G chip.

The step S110 may be implemented by the 5G chip of the communication device. After the communication device synchronizes with the base station by the 5G chip, the communication device may use the 5G chip to read a broadcast signal of the base station, and acquire the timeslot ratio information of the uplink timeslot and the downlink timeslot from the broadcast signal of the base station. The timeslot ratio information may represent a ratio of the uplink timeslot to the downlink timeslot.

In an embodiment of the present disclosure, after performing synchronization with the base station, the 5G chip may be used to read a first system information block (SIB1) and acquire the timeslot ratio information from the first system information block.

In step S120, on-off states of an amplification uplink and an amplification downlink are controlled by a 4G chip based on the timeslot ratio information.

The step S120 may be implemented by the 4G chip of the communication device. The 4G chip may acquire the timeslot ratio information determined by the 5G chip, so that the 4G chip may control the on-off states of the amplification uplink and the amplification downlink based on the timeslot ratio information.

It can be seen that the 5G chip of the communication device performs synchronization with a base station, and the 4G chip of the communication device controls on-off states of the amplification uplink and the amplification downlink based on the timeslot ratio information of the uplink timeslot and the downlink timeslot acquired by the 5G chip, so that the 4G chip can realize the on-off control of the amplification uplink and the amplification downlink of the communication device under the 5G communication after the 5G chip establishes 5G connection and synchronization with the base station. In this way, an outdoor base station signal can be amplified and transmitted indoors through the amplification downlink, and an indoor signal can be transmitted outdoors through the amplification uplink, thereby achieving 5G communication control on a basis of 4G.

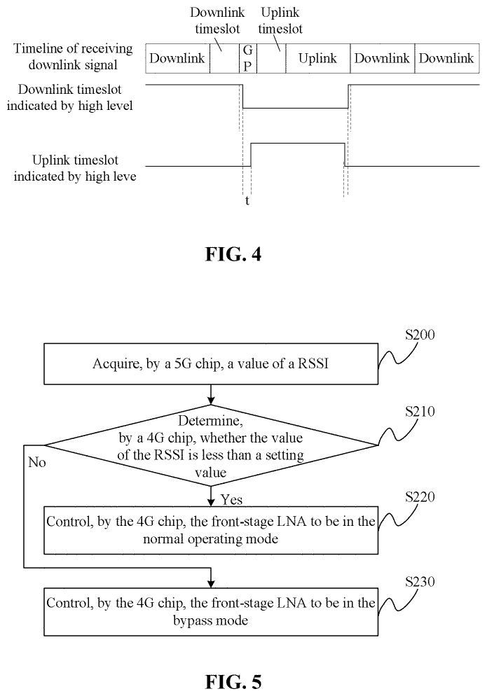

In an embodiment, as shown in FIG. 4, the on-off states of the amplification uplink and the amplification downlink may be controlled based on the timeslot ratio information in accordance with at least one of the following principles.

A turn-on time period of the amplification downlink is controlled to cover all downlink timeslot transmission time periods. Similarly, a turn-on time period of the amplification uplink is controlled to cover all uplink timeslot transmission time periods.

Alternatively, an end time instant of the amplification downlink and a start time instant of the amplification uplink are controlled to have a preset guard time interval (e.g., a guard time interval t as shown in FIG. 4) therebetween, to avoid self-excitation of an uplink-downlink closed loop caused by the amplification uplink and the amplification downlink being simultaneously in an on state for a short time period.

It should be noted that GP (guard space) in FIG. 4 may be determined according to a length of the uplink timeslot and a length of the downlink timeslot. A cell radius supported by the communication device may depend on the length of GP.

In the communication control method according to the embodiments of the present disclosure, a communication device (such as a repeater or an indoor distribution system) may perform cell search and synchronization with a base station through a 5G chip, and acquire timeslot ratio information of an uplink timeslot and a downlink timeslot, so that the communication device can control on-off states of the amplification uplink and the amplification downlink based on the timeslot ratio information through a 4G chip after the communication device establishes 5G connection and synchronization with the base station through the 5G chip. It can be seen that in the embodiments of the present disclosure, the 4G chip of the communication device can realize on-off control of the amplification uplink and the amplification downlink of the communication device under 5G communication after the 5G chip of the communication device establishes the 5G connection and synchronization with the base station, so that an outdoor base station signal can be amplified and transmitted indoors via the amplification downlink, and an indoor signal can be transmitted to outdoors via the amplification uplink, thereby achieving 5G communication control on a basis of 4G.

In an embodiment, the 5G chip of the communication device may further acquire a value of a RSSI (Received Signal Strength Indication) and provide the value of the RSSI to the 4G chip of the communication device. Thus the 4G chip may acquire the value of the RSSI provided by the 5G chip, and control a front-stage LNA (low noise amplifier) of the communication device to be in a normal operating mode or in a bypass mode according to the value of the RSSI. In an embodiment, FIG. 5 shows a flow chart of a communication control method according to another embodiment of the present disclosure. As shown in FIG. 5, the process may include the following step S200 to S230.

In step S200, a value of a RSSI is acquired by a 5G chip.

In step S210, it is determined by a 4G chip whether the value of the RSSI is less than a setting value. In a case that the value of the RSSI is less than the setting value, step S220 is performed. In a case that the value of the RSSI is greater than or equal to the setting value, step S230 is performed.

In step S220, the front-stage LNA is controlled to be in the normal operating mode by the 4G chip.

In step S230, the front-stage LNA is controlled to be in the bypass mode by the 4G chip.

In an embodiment, in a case that the value of the RSSI is less than the setting value, the 4G chip may be used to control the front-stage LNA to be in the normal operating mode. In a case that the value of the RSSI is greater than or equal to the setting value, the 4G chip may be used to control the front-stage LNA to be in the bypass mode. The setting value may be determined according to the actual situation, for example, may be equal to −45 dbm, which is not limited in the embodiment of the present disclosure.

It should be noted that, as shown in FIG. 1, the front-stage LNA of the communication device is configured to amplify a signal transmitted from the outdoor to the indoor on the amplification downlink, and amplify a signal transmitted from the indoor to the outdoor on the amplification uplink. In the embodiment of the present disclosure, the 4G chip determines whether the front-stage LNA is in the normal operating mode or in the bypass mode based on the value of the RSSI provided by the 5G chip, which can further control the amplification uplink and amplification downlink, thereby achieving the 5G communication control on a basis of 4G.

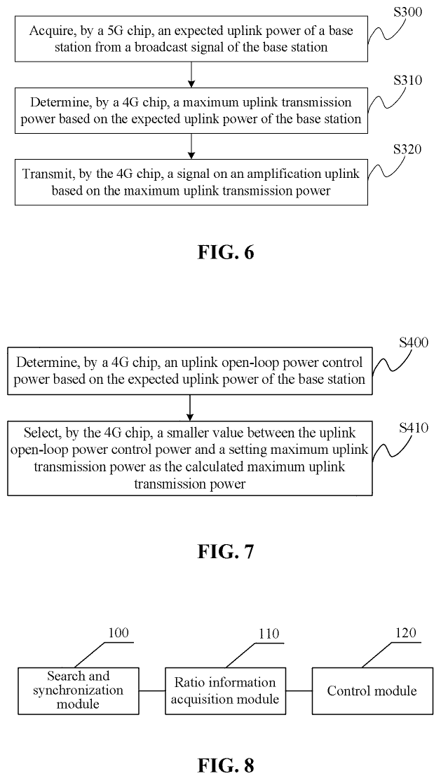

In an embodiment, if the communication device enables an open-loop power control function, the 5G chip may acquire an expected uplink power of the base station from the broadcast signal of the base station and provide the expected uplink power to the 4G chip. Thus the 4G chip may determine a maximum uplink transmission power based on the expected uplink power of the base station, so that the 4G chip may transmit a signal on the amplification uplink based on the determined maximum uplink transmission power, so as to achieve the uplink transmission of a 5G communication signal on a basis of 4G. In an embodiment, FIG. 6 shows a process of a communication control method according to another embodiment of the present disclosure. As shown in FIG. 6, the process may include the following steps S300 to S320.

In step S300, an expected uplink power of a base station is acquired from a broadcast signal of the base station by a 5G chip.

In step S310, a maximum uplink transmission power is determined based on the expected uplink power of the base station by a 4G chip.

In an embodiment, after acquiring the expected uplink power of the base station, the 5G chip may transmit the expected uplink power of the base station to the 4G chip, and the 4G chip may calculate the maximum uplink transmission power based on the expected uplink power of the base station.

In an embodiment, the step S310 may be implemented by the following steps S400 and S410 as shown in FIG. 7.

In step S400, an uplink open-loop power control power is determined based on the expected uplink power of the base station by the 4G chip.

In an embodiment, the expected uplink power of the base station may represent a power strength at which the base station expects a signal to arrive the base station. In the embodiment of the present disclosure, the uplink open-loop power control power may be determined based on the expected uplink power of the base station. The uplink open-loop power control power may be considered as an open-loop power control power of the amplification uplink in a case that the communication device enables the open-loop power control function.

In an embodiment of the present disclosure, the uplink open-loop power control power may be calculated according to the following equation (1):

Power_ul_open=Power_p0n_pusch+α*PL+10log 10(RBnum)+offset, (1)
where, Power_ul_open represents the uplink open-loop power control power; Power_p0n_pusch represents the expected uplink power of the base station, indicating the power strength at which the base station expects a signal to arrive the base station; α represents a path-loss correction coefficient, and the value of α may be set according to the actual situation, such as α is set to 1; PL may be expressed as (Power_rs-RSRP), in which Power_rs represents a reference signal transmission power and may be acquired from the broadcast signal of the base station, and RSRP represents a reference signal receiving power and may be acquired through measurement; 10log 10(RBnum) represents a power offset after a number of RBs (resource blocks) are configured for a SRS (sounding reference signal); and offset represents a setting offset value.

In step S410, a smaller value between the uplink open-loop power control power and a setting maximum uplink transmission power is selected by the 4G chip as the calculated maximum uplink transmission power.

In an embodiment of the present disclosure, after the uplink open-loop power control power is determined based on the expected uplink power of the base station, the setting maximum uplink transmission power may be called and the value of the setting maximum uplink transmission power may be set according to the actual situation, so that a smaller value between the uplink open-loop power control power and the setting maximum uplink transmission power may be selected as the maximum uplink transmission power in the embodiment of the present disclosure, that is, the smaller one of the uplink open-loop power control power and the setting maximum uplink transmission power is determined as the maximum uplink transmission power.

In an embodiment, the maximum uplink transmission power may be calculated according to the following equation (2):

Power_ul_max=min(Power_ul_max_set, Power_ul_open), (2)
where, Power_ul_max represents the calculated maximum uplink transmission power; Power_ul_max_set represents the setting maximum uplink transmission power, and Power_ul_max_set may be preset according to the actual situation, for example, may be set to 17 dbm, which is not limited in the embodiment of the present disclosure; Power_ul_open represents the uplink open-loop power control power.

Returning to FIG. 6, step S320 may be performed in an embodiment of the present disclosure. In step S320, a signal is transmitted by the 4G chip on an amplification uplink based on the maximum uplink transmission power.

In an embodiment of the present disclosure, after the maximum uplink transmission power is calculated, and the power strength at which the base station expects a signal to arrive the base station is determined, the signal is transmitted on the amplification uplink based on the maximum uplink transmission power, so that a signal transmitted from the indoor to the outdoor, when arriving the base station, can meet the power strength at which the base station expects a signal arriving the base station, thereby achieving accurate 5G communication control on a basis of 4G on the amplification uplink.

Further in an embodiment, the 5G chip of the communication device may acquire a downlink power of the base station from the broadcast signal of the base station, so that the 4G chip can calculate a maximum downlink power based on the downlink power of the base station. Furthermore, the 4G chip may transmit a signal with the maximum downlink power on the amplification downlink based on the calculated maximum downlink power, thereby achieving accurate 5G communication control on a basis of 4G on the amplification downlink.

In the communication control method according to an embodiment of the present disclosure, the 4G chip may control 2G, 3G or 4G signal, and synchronously control 5G signal communication, thereby achieving multi-functional 5G synchronization and control. The solution of the embodiment of the present disclosure may be used for reconstruction of a wireless remote repeater or indoor distribution system, specifically for a near-end control combining unit system and a far-end control combining unit system of the repeater or the indoor distribution system, achieving the control of the 2G/3G/4G signal and the 5G signal based on the 4G chip. A near-end of the indoor distribution system refers to an end of a master node, and the far-end of the indoor distribution system refers to an end of a slave node.

According to the solution of the embodiment of the present disclosure, the forwarding of 2G/3G/4G signal and the 5G signal can be controlled, and after the communication device is synchronized with the base station, the ratio of the uplink timeslot to the downlink timeslot, a 4G/5G frame header offset, a rated output power, a gain, an input signal frequency band, a frequency point, RSRP (reference signal receiving power), SINR (signal to interference noise ratio), CellID (ID of a cell) and other network parameters in the 4G/5G mode channel can be queried. Moreover, according to the embodiment of the present disclosure, it may determined whether the front-stage LNA is in the normal operating mode or in the bypass mode according to the value of the RSSI. The expected uplink power and the downlink power of the base station may be acquired from the broadcast signal of the base station, and the maximum uplink transmission power of the amplification uplink is calculated, thereby achieving accurate communication control on the amplification uplink and accurate communication control on the amplification downlink.

Multiple solutions according to the embodiments of the present disclosure are described in detail above. The solutions described in the embodiments may be combined with each other and referenced with each other in a case of no conflict, thus, to extend multiple possible solutions of embodiments, which may be considered as solutions disclosed in embodiments of the present disclosure.

A communication control apparatus according to an embodiment of the present disclosure is described below. The communication control apparatus described below may be considered as a functional module of the communication device necessary to implement the communication control method according to the embodiments of the present disclosure. The content of the communication control method described above may be referenced to the content of the communication control apparatus described below.

In an embodiment, FIG. 8 is a block diagram of a communication control apparatus according to an embodiment of the present disclosure. As shown in FIG. 8, the communication control apparatus may include a search and synchronization module 100, a ratio information acquisition module 110, and a control module 120.

The search and synchronization module 100 is configured to perform cell search and synchronization with a base station through a 5G chip.

The ratio information acquisition module 110 is configured to acquire timeslot ratio information of an uplink timeslot and a downlink timeslot through the 5G chip.

The control module 120 is configured to control on-off states of an amplification uplink and an amplification downlink based on the timeslot ratio information through a 4G chip.

In an embodiment, the control module 120 is configured to control on-off states of an amplification uplink and an amplification downlink based on the timeslot ratio information through a 4G chip, and specifically:
control a turn-on time period of the amplification downlink to cover all downlink timeslot transmission time periods through the 4G chip, and control a turn-on time period of the amplification uplink to cover all uplink timeslot transmission time periods through the 4G chip; and/or
control a preset guard time interval to exist between an end time instant of the amplification downlink and a start time instant of the amplification uplink through the 4G chip.

In an embodiment, the ratio information acquisition module 110 is configured to acquire timeslot ratio information of an uplink timeslot and a downlink timeslot through the 5G chip, and specifically:
read a broadcast signal of a base station and acquire the timeslot ratio information of the uplink timeslot and the downlink timeslot from the broadcast signal of the base station through the 5G chip.

In an embodiment, the ratio information acquisition module 110 is configured to read a broadcast signal of a base station, and acquire the timeslot ratio information of the uplink timeslot and the downlink timeslot from the broadcast signal of the base station through the 5G chip, and specifically:
read a first system information block and acquire the timeslot ratio information from the first system information block through the 5G chip.

In an embodiment, FIG. 9 is a block diagram of a communication control apparatus according to another embodiment of the present disclosure. Combined with FIG. 8 and FIG. 9, the apparatus may further include a RSSI value acquisition module 130 and a mode control module 140. The RSSI value acquisition module 130 is configured to acquire a value of a RSSI through the 5G chip. The mode control module 140 is configured to control a front-stage LNA to be in a normal operating mode or in a bypass mode according to the value of the RSSI through the 4G chip.

In an embodiment, the mode control module 140 is configured to control a front-stage LNA to be in a normal operating mode or in a bypass mode according to the value of the RSSI through the 4G chip, and specifically:
control the front-stage LNA to be in the normal operating mode through the 4G chip, in a case that the value of the RSSI is less than a setting value; and
control the front-stage LNA to be in the bypass mode through the 4G chip, in a case that the value of the RSSI is greater than or equal to the setting value.

It should be noted that the communication control method described above may be implemented by a software program, and the software program runs in a processor integrated in a chip or a chip module.

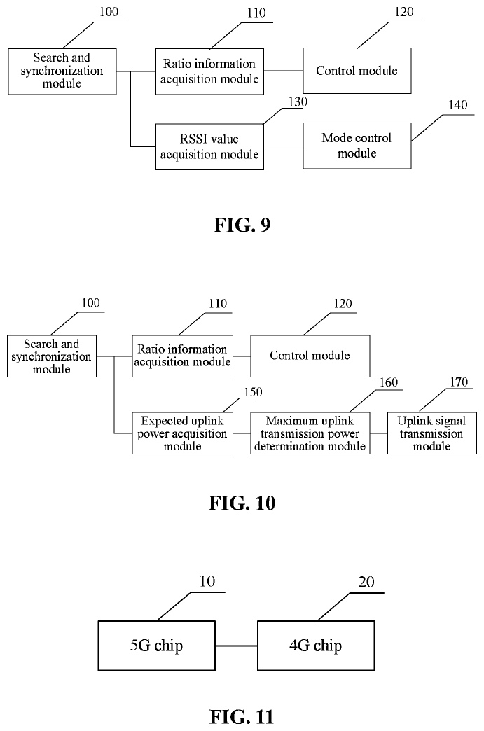

In an embodiment, FIG. 10 is a block diagram of a communication control apparatus according to another embodiment of the present disclosure. Combined with FIG. 8 and FIG. 10, the apparatus may further include: an expected uplink power acquisition module 150, a maximum uplink transmission power determination module 160, and an uplink signal transmission module 170. The expected uplink power acquisition module 150 is configured to acquire an expected uplink power of the base station from the broadcast signal of the base station through the 5G chip. The maximum uplink transmission power determination module 160 is configured to determine a maximum uplink transmission power based on the expected uplink power of the base station through the 4G chip. The uplink signal transmission module 170 is configured to transmit a signal on the amplification uplink based on the maximum uplink transmission power through the 4G chip.

In an embodiment, the maximum uplink transmission power determination module 160 is configured to determine a maximum uplink transmission power based on the expected uplink power of the base station through the 4G chip, and specifically:
determine an uplink open-loop power control power based on the expected uplink power of the base station through the 4G chip; and
select a smaller value between the uplink open-loop power control power and a setting maximum uplink transmission power as a calculated maximum uplink transmission power through the 4G chip.

In an embodiment, the search and synchronization module 100 is configured to perform synchronization with a base station through a 5G chip, and specifically:
receive a downlink base station signal and perform synchronization with the base station based on the downlink base station signal through the 5G chip.

In an embodiment, the communication control apparatus may correspond to a chip with data processing function in user equipment, such as a baseband chip; or may correspond to a chip module including a chip with data processing function in user equipment; or may correspond to user equipment.

A communication device is further provided according to an embodiment of the present disclosure. The communication device may be a repeater or an indoor distribution system (such as a master node in the indoor distribution system). As shown in FIG. 11, the communication device may include a 5G chip 10 and a 4G chip 20. The 5G chip is configured to perform cell search and synchronization with a base station and acquire timeslot ratio information of an uplink timeslot and a downlink timeslot. The 4G chip is configured to control on-off states of an amplification uplink and an amplification downlink based on the timeslot ratio information.

In an embodiment, the 4G chip is configured to control on-off states of an amplification uplink and an amplification downlink based on the timeslot ratio information, and specifically:
control a turn-on time period of the amplification downlink to cover all downlink timeslot transmission time periods, and control a turn-on time period of the amplification uplink to cover all uplink timeslot transmission time periods; and/or
control a preset guard time interval to exist between an end time instant of the amplification downlink and a start time instant of the amplification uplink.

In an embodiment, the 5G chip is configured to acquire timeslot ratio information of an uplink timeslot and a downlink timeslot, and specifically:
read a broadcast signal of a base station and acquire the timeslot ratio information of the uplink timeslot and the downlink timeslot from the broadcast signal of the base station.

In an embodiment, the 5G chip is configured to read a broadcast signal of a base station, and acquire timeslot ratio information of the uplink timeslot and the downlink timeslot from the broadcast signal of the base station, and specifically:
read a first system information block and acquire the timeslot ratio information from the first system information block.

In an embodiment, the 5G chip is further configured to acquire a value of a RSSI. The 4G chip is further configured to control a front-stage LNA to be in a normal operating mode or in a bypass mode according to the value of the RSSI.

In an embodiment, the 4G chip is configured to control a front-stage LNA to be in a normal operating mode or in a bypass mode according to the value of the RSSI, and specifically:
control the front-stage LNA to be in the normal operating mode, in a case that the value of the RSSI is less than a setting value; and
control the front-stage LNA to be in the bypass mode, in a case that the value of the RSSI is greater than or equal to the setting value.

In an embodiment, the 5G chip is further configured to acquire an expected uplink power of a base station from a broadcast signal of the base station. The 4G chip is further configured to determine a maximum uplink transmission power based on the expected uplink power of the base station and transmit a signal on the amplification uplink based on the maximum uplink transmission power.

In an embodiment, the 4G chip is configured to determine a maximum uplink transmission power based on the expected uplink power of the base station, and specifically:
determine an uplink open-loop power control power based on the expected uplink power of the base station; and
select a smaller value between the uplink open-loop power control power and a setting maximum uplink transmission power as the calculated maximum uplink transmission power.

In an embodiment, the 5G chip is configured to perform synchronization with a base station, and specifically:
receive a downlink base station signal and perform synchronization with the base station based on the downlink base station signal.

The embodiments of the present disclosure may achieve 5G communication control on a basis of 4G.

A storage medium is further provided according to an embodiment of the present disclosure. The storage medium may store one or more pieces of computer executable instructions. The one or more pieces of computer executable instructions may be used to perform the communication control method according to the embodiments of the present disclosure. In an embodiment, the 5G chip and the 4G chip may call and execute corresponding instructions in the one or more pieces of computer executable instructions, so as to perform the communication control method according to the embodiments of the present disclosure.

Each module/unit included in each apparatus and product described in the above embodiments may be a software module/unit or may be a hardware module/unit. Alternatively, part of the modules/units may be a software module/unit, and part of the modules/units is a hardware module/unit. For example, for each apparatus or product applied to or integrated in a chip, modules/units included therein may be implemented by hardware such as circuits, or at least part of the modules/units may be implemented by software programs which run on a processor integrated inside the chip, and the remaining part (if any) of the modules/units may be implemented by hardware such as circuits. For each apparatus and product applied to or integrated in a chip module, the modules/units included therein may be implemented by hardware such as circuits, and different modules/units may be disposed in a same component (e.g., a chip, circuit module) or in different components of the chip module; or, at least part of the modules/units may be implemented by software programs which run on a processor integrated inside the chip module, and the remaining part (if any) of the modules/units may be implemented by hardware such as circuits. For each apparatus and product applied to or integrated in a terminal, modules/units included therein may be implemented by hardware such as circuits, and different modules/units may be disposed in a same component (e.g., a chip, a circuit module) or in different components of the terminal; or, at least part of the modules/units may be implemented by software programs which run on a processor integrated inside the terminal, and the remaining part (if any) of the modules/units may be implemented by hardware such as circuits.

Although the embodiments of the present disclosure are disclosed above, the present disclosure is not limited thereto. Any changes and modifications may be made by those skilled in the art without departing from the spirit and scope of the present disclosure, and the scope of the present disclosure should be based on the scope defined by the claims.

1. A communication control method, comprising:
performing, by a 5G chip, cell search and synchronization with a base station;
acquiring, by the 5G chip, timeslot ratio information of an uplink timeslot and a downlink timeslot; and
controlling, by a 4G chip, on-off states of an amplification uplink and an amplification downlink based on the timeslot ratio information.

2. The communication control method according to claim 1, wherein the controlling, by the 4G chip, the on-off states of the amplification uplink and the amplification downlink based on the timeslot ratio information comprises:
controlling, by the 4G chip, a turn-on time period of the amplification downlink to cover all downlink timeslot transmission time periods, and controlling, by the 4G chip, a turn-on time period of the amplification uplink to cover all uplink timeslot transmission time periods; and/or
controlling, by the 4G chip, a preset guard time interval to exist between an end time instant of the amplification downlink and a start time instant of the amplification uplink.

3. The communication control method according to claim 1, wherein the acquiring, by the 5G chip, the timeslot ratio information of the uplink timeslot and the downlink timeslot comprises:
reading, by the 5G chip, a broadcast signal of the base station, and
acquiring, by the 5G chip, the timeslot ratio information of the uplink timeslot and the downlink timeslot from the broadcast signal of the base station.

4. The communication control method according to claim 3, wherein the reading, by the 5G chip, the broadcast signal of the base station, and acquiring, by the 5G chip, the timeslot ratio information of the uplink timeslot and the downlink timeslot from the broadcast signal of the base station comprises:
reading, by the 5G chip, a first system information block, and
acquiring, by the 5G chip, the timeslot ratio information from the first system information block.

5. The communication control method according to claim 1, further comprising:
acquiring, by the 5G chip, a value of a received signal strength indication (RSSI); and
controlling, by the 4G chip, a front-stage low noise amplifier (LNA) to be in a normal operating mode or in a bypass mode according to the value of the RSSI.

6. The communication control method according to claim 5, wherein the controlling, by the 4G chip, the front-stage low noise amplifier (LNA) is in the normal operating mode or in the bypass mode according to the value of the RSSI comprises:
controlling, by the 4G chip, the front-stage LNA to be in the normal operating mode, in a case that the value of the RSSI is less than a setting value; and
controlling, by the 4G chip, the front-stage LNA to be in the bypass mode, in a case that the value of the RSSI is greater than or equal to the setting value.

7. The communication control method according to claim 1, further comprising:
acquiring, by the 5G chip, an expected uplink power of the base station from a broadcast signal of the base station;
determining, by the 4G chip, a maximum uplink transmission power based on the expected uplink power of the base station; and
transmitting, by the 4G chip, a signal on the amplification uplink based on the maximum uplink transmission power.

8. The communication control method according to claim 7, wherein the determining, by the 4G chip, the maximum uplink transmission power based on the expected uplink power of the base station comprises:
determining, by the 4G chip, an uplink open-loop power control power based on the expected uplink power of the base station; and
selecting, by the 4G chip, a smaller value between the uplink open-loop power control power and a setting maximum uplink transmission power as the maximum uplink transmission power.

9. The communication control method according to claim 1, wherein the performing, by the 5G chip, synchronization with the base station comprises:
receiving, by the 5G chip, a downlink base station signal, and
performing, by the 5G chip, synchronization with the base station based on the downlink base station signal.

10. (canceled)

11. A communication device, comprising a 5G chip and a 4G chip, wherein
the 5G chip is configured to perform cell search and synchronization with a base station, and acquire timeslot ratio information of an uplink timeslot and a downlink timeslot; and
the 4G chip is configured to control on-off states of an amplification uplink and an amplification downlink based on the timeslot ratio information.

12. A non-transitory computer-readable storage medium, wherein the storage medium stores one or more pieces of computer executable instructions, and the one or more pieces of computer executable instructions, when executed by a 5G chip, cause the 5G chip to:
perform cell search and synchronization with a base station; and
acquire timeslot ratio information of an uplink timeslot and a downlink timeslot,
wherein the one or more pieces of computer executable instructions, when executed by a 4G chip, cause the 4G chip to:
control on-off states of an amplification uplink and an amplification downlink based on the timeslot ratio information.

13. The communication device according to claim 11, wherein
the 4G chip is further configured to: control a turn-on time period of the amplification downlink to cover all downlink timeslot transmission time periods, and control a turn-on time period of the amplification uplink to cover all uplink timeslot transmission time periods;
and/or,
the 4G chip is further configured to: control a preset guard time interval to exist between an end time instant of the amplification downlink and a start time instant of the amplification uplink.

14. The communication device according to claim 11, wherein the 5G chip is further configured to:
read a broadcast signal of the base station; and
acquire the timeslot ratio information of the uplink timeslot and the downlink timeslot from the broadcast signal of the base station.

15. The communication device according to claim 14, wherein the 5G chip is further configured to:
read a first system information block; and
acquire the timeslot ratio information from the first system information block.

16. The communication device according to claim 11, wherein the 5G chip is further configured to acquire a value of a received signal strength indication (RSSI), and
the 4G chip is further configured to control a front-stage low noise amplifier (LNA) to be in a normal operating mode or in a bypass mode according to the value of the RSSI.

17. The communication device according to claim 16, wherein the 4G chip is further configured to:
control the front-stage LNA to be in the normal operating mode, in a case that the value of the RSSI is less than a setting value; and
control the front-stage LNA to be in the bypass mode, in a case that the value of the RSSI is greater than or equal to the setting value.

18. The communication device according to claim 11, wherein
the 5G chip is further configured to acquire an expected uplink power of the base station from a broadcast signal of the base station,
the 4G chip is further configured to determine a maximum uplink transmission power based on the expected uplink power of the base station and transmit a signal on the amplification uplink based on the maximum uplink transmission power.

19. The communication device according to claim 18, wherein the 4G chip is further configured to:
determine an uplink open-loop power control power based on the expected uplink power of the base station; and
select a smaller value between the uplink open-loop power control power and a setting maximum uplink transmission power as the maximum uplink transmission power.

20. The communication device according to claim 11, wherein the 5G chip is further configured to receive a downlink base station signal and perform synchronization with the base station based on the downlink base station signal.
